(19) United States
(12) Patent Application Publication
(10) Pub. No.: US 2016/0296954 A1
(43) Pub. Date: Oct. 13, 2016

(54) AIR DISTRIBUTION DEVICE FOR SPRAY GUN

(71) Applicant: Kuei-Hsiang Shih, Taichung (TW)

(72) Inventor: Kuei-Hsiang Shih, Taichung (TW)

(21) Appl. No.: 14/684,360

(22) Filed: Apr. 11, 2015

(51) Int. Cl. B05B 7/06; B05B 15/04

(52) U.S. Cl. CPC B05B 7/066; B05B 15/0431

(57) ABSTRACT

A spray gun includes a body having a recessed seat at the front end thereof. Multiple outputs are defined through the seat. A distribution plate is located in the seat and an inner nozzle is pivotably connected to the distribution plate. A fixing ring is threadedly connected to the front end of the body. An outer nozzle is connected to the fixing ring. The distribution plate has a flange extending from the inner periphery thereof. A hole is formed at the center of the flange. Multiple inner blades extend alternatively from the inner periphery of the flange, and multiple outer blades extend alternatively from the outer periphery of the distribution plate. The air pressure is evenly distributed via the inner and outer blades of the distribution plate so that the paint is sprayed evenly.

### BACKGROUND OF THE INVENTION

1. Fields of the Invention

The present invention relates to a spray gun, and more particularly, to an air distribution device of a spray gun so as to evenly spray the paint.

2. Descriptions of Related Art

The conventional spray gun includes a distribution device located between the nozzle and the body of the gun so as to distribute the air flow through the gaps to evenly distribute the air pressure through the distribution device. By the distribution device, the paint is evenly sprayed from the nozzle.

The gaps between the nozzle and the body of the gun are small and expect to obtain sufficient pressure, however, the small gaps restrict the volume of air passing through the gaps so that the feature of atomization of the paint is not satisfied.

The smaller gaps between the nozzle and the body of the gun allow the input air volume to be larger than the output air volume so as to generate even pressure distribution when passing through the distribution device. Nevertheless, the position that the input air is located at the high pressure zone which is located at a distance from the distribution device, so that the air flows are not steady and the pressure may vary, so that the spray work cannot be maintained in a stable and consist status. The spray area become irregular.

The present invention intends to provide a distribution device of a spray gun so as to eliminate the shortcomings mentioned above.

### SUMMARY OF THE INVENTION

The present invention relates to a spray gun and comprises a body having a recessed seat formed at the front end thereof. Multiple outputs are defined through the seat. A distribution plate is located in the seat and an inner nozzle is pivotably connected to the distribution plate and fixed to the body. A fixing ring is threadedly connected to the front end of the body. An outer nozzle is connected to the fixing ring by a C-clip. A seal ring is located between the fixing ring and the front end of the body.

Preferably, the distribution plate has a flange extending from the inner periphery thereof. A hole is formed at the center of the flange. Multiple inner blades extend alternatively from the inner periphery of the flange, and multiple outer blades extend alternatively from the outer periphery of the distribution plate.

The primary object of the present invention is to provide a spray gun which has a distribution plate with alternative inner blades and outer blades so as to evenly guide the air flows to spray the paint evenly.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of the spray gun of the present invention;

FIG. 2 is a cross sectional view showing the air flows are distributed via the distribution plate of the spray gun of the present invention;

FIG. 3 shows the distribution plate of the spray gun of the present invention;

FIG. 3-1 shows the cross sectional view of the distribution plate with the inner blades and the air flows passing through the distribution plate, and

FIG. 4 shows the distribution plate with the outer blades and the air flows passing through the distribution plate.

### DETAILED DESCRIPTION OF THE PREFERRED EMBODIMENT

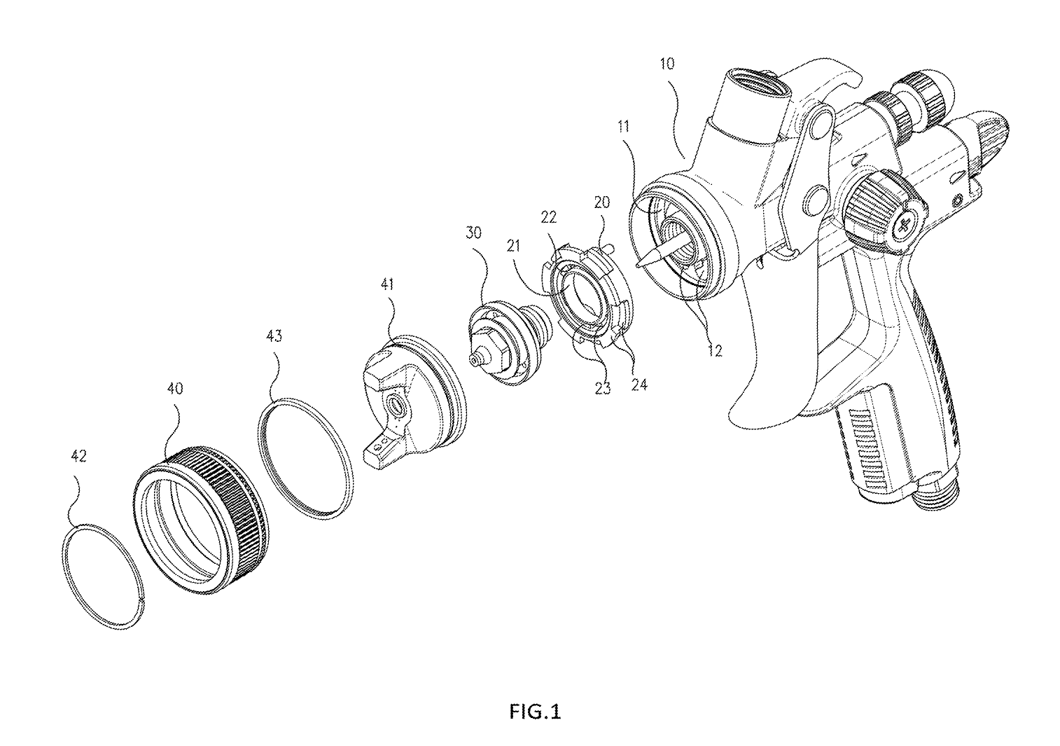

Referring to FIGS. 1 to 4, the spray gun of the present invention comprises a body 10 having a recessed seat 11 formed at the front end thereof. Multiple outputs 12 are defined through the seat 11.

A distribution plate 12 is located in the seat 11 and has a flange 22 extending from the inner periphery thereof. A hole 21 is formed at the center of the flange 22. Multiple inner blades 23 extend alternatively from the inner periphery of the flange 22. Multiple outer blades 24 extend alternatively from the outer periphery of the distribution plate 12.

An inner nozzle 30 is pivotably connected to the distribution plate 12 and fixed to the body 10. A fixing ring 40 is threadedly connected to the front end of the body 10. An outer nozzle 41 is connected to the fixing ring 40 by a C-clip 42. A seal ring 43 is located between the fixing ring 40 and the front end of the body 10.

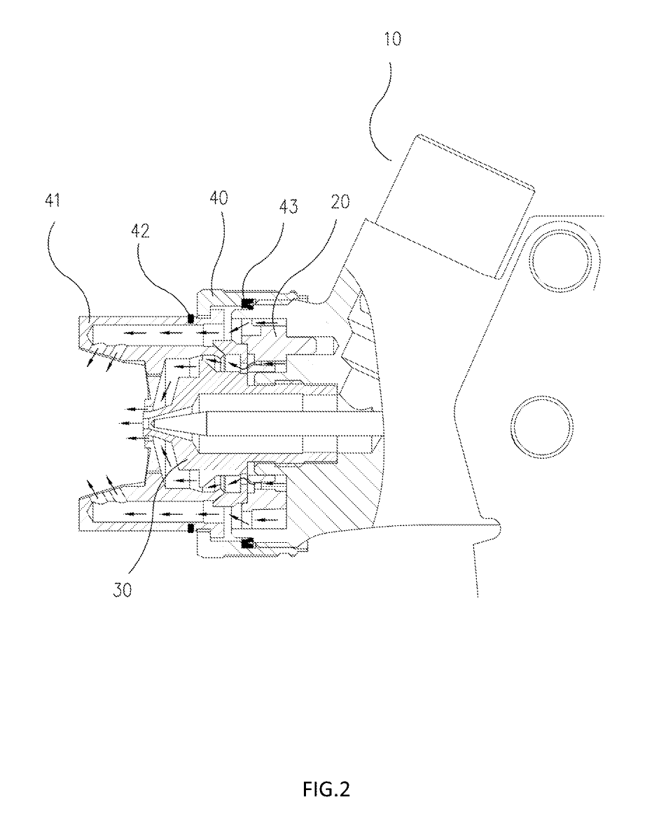

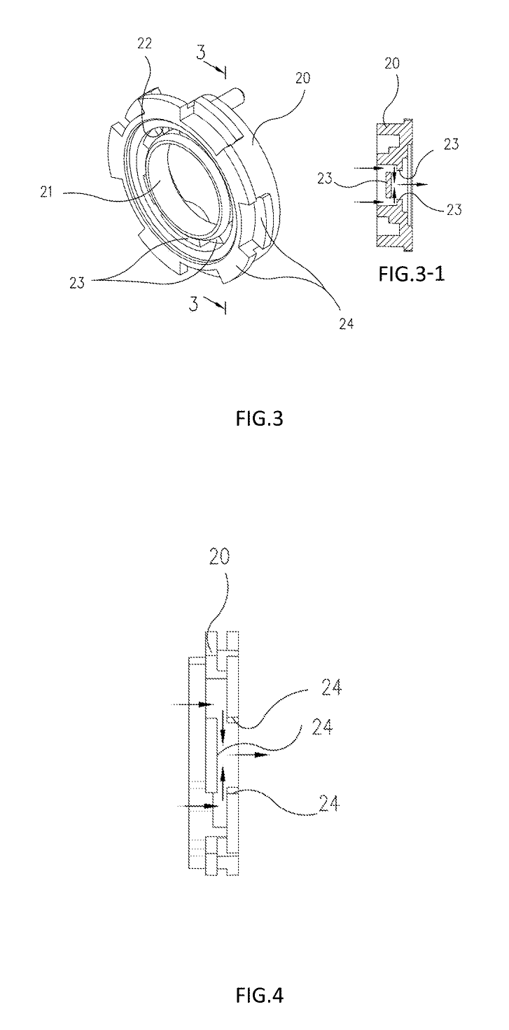

When in use, the air flows are guided toward the inner nozzle 30 and the outer nozzle 41 as shown in FIG. 2. As shown in FIGS. 3 and 4, because the inner and outer blades 23, 24 are located alternative to each other, the air flows through the front end of the body 10 are guided to pass through the gaps between the inner and outer blades 23, 24, and then collected and flow to the inner and outer nozzles 30, 41.

The advantages of the present invention are that the cross sectional area of the air flows is not restricted so that a larger volume of air can be obtained. Besides, the air flows pass through the gaps between the inner and outer blades 23, 24, and then collected and flow to the inner and outer nozzles 30, 41. The air flows are stable and the quality of spray of the paint is controlled and satisfied.

While we have shown and described the embodiment in accordance with the present invention, it should be clear to those skilled in the art that further embodiments may be made without departing from the scope of the present invention.

What is claimed is:

1. A spray gun comprising:
a body having a recessed seat formed at a front end thereof, multiple outputs defined through the seat;
a distribution plate located in the seat;
an inner nozzle pivotably connected to the distribution plate and fixed to the body, and
a fixing ring threadedly connected to the front end of the body, an outer nozzle connected to the fixing ring by a C-clip, a seal ring located between the fixing ring and the front end of the body.

2. The spray gun as claimed in claim 1, wherein the distribution plate has a flange extending from an inner periphery of the distribution plate, a hole is formed at a center of the flange, multiple inner blades extend alternatively from an inner periphery of the flange, multiple outer blades extend alternatively from an outer periphery of the distribution plate.
